(19) United States
(12) Patent Application Publication
(10) Pub. No.: US 2015/0073860 A1
(43) Pub. Date: Mar. 12, 2015

(54) PRODUCTION MANAGEMENT DEVICE AND PRODUCTION MANAGEMENT PROGRAM

(71) Applicant: Kabushiki Kaisha Toshiba, Minato-ku (JP)

(72) Inventors: Masato KIMOTO, Kuwana (JP); Yasunori TAKASE, Yokohama (JP); Michio ITO, Yokkaichi (JP); Noboru HODAMA, Yokkaichi (JP); Takahito NAKAJIMA, Mie (JP)

(73) Assignee: Kabushiki Kaisha Toshiba, Minato-ku (JP)

(21) Appl. No.: 14/460,894

(22) Filed: Aug. 15, 2014

(30) Foreign Application Priority Data
Sep. 6, 2013 (JP) 2013-184581

(51) Int. Cl. G06Q 10/06

(52) U.S. Cl. CPC G06Q 10/0635
USPC 705/7.28

(57) ABSTRACT

According to one embodiment, a data input unit inputs data affecting progress of production, a development risk calculation unit calculates development risks related to development time of the production based on results of classification of the data, a production capability calculation unit calculates production capabilities by process based on results of analysis of the data, and an expected value calculation unit calculates expected values of production volume by process based on the development risks and the production capabilities.

### CROSS-REFERENCE TO RELATED APPLICATIONS

This application is based upon and claims the benefit of priority from Japanese Patent Application No. 2013-184581, filed on Sep. 6, 2013; the entire contents of which are incorporated herein by reference.

### FIELD

Embodiments described herein relate generally to a production management device and a production management program.

### BACKGROUND

Production management devices are subject to day-to-day fluctuations in operation rate and processing time depending on workers' levels of skill, occurrence of troubles, and the like, which results in a delay from a production plan. Measures are taken against such a delay from a production plan by operators' qualitative instincts and experiences.

### BRIEF DESCRIPTION OF THE DRAWINGS

FIG. 1 is a block diagram of a schematic configuration of a production management device according to an embodiment;

FIG. 2 is a block diagram illustrating a method for establishing a model in a method for production management according to the embodiment;

FIG. 3 is a diagram illustrating a list of extraction examples of factors in past activity items;

FIG. 4 is a diagram illustrating one example of variables for use in multiple regression analysis illustrated in FIG. 2;

FIG. 5 is a block diagram illustrating a method for calculating a development probability in a prediction item;

FIG. 6 is a diagram illustrating one example of difficulty level ranks in a prediction item;

FIG. 7 is a diagram illustrating distribution of development delays in a prediction item;

FIG. 8 is a diagram illustrating one example of development probabilities in a prediction item;

FIG. 9 is a diagram illustrating a display example of success rates according to production capabilities by process; and

FIG. 10 is a block diagram illustrating a hardware configuration example of a production management device according to the embodiment.

### DETAILED DESCRIPTION

In general, according to one embodiment, a data input unit, a development risk calculation unit, a production capability calculation unit, and an expected value calculation unit are provided. The data input unit inputs data affecting the progress of production. The development risk calculation unit calculates a development risk related to development time of the production based on results of classification of the data. The production capability calculation unit calculates production capabilities by process, based on results of analysis of the data. The expected value calculation unit calculates expected values of production volume by process.

Exemplary embodiments of a production management device will be explained below in detail with reference to the accompanying drawings. The present invention is not limited to the following embodiments.

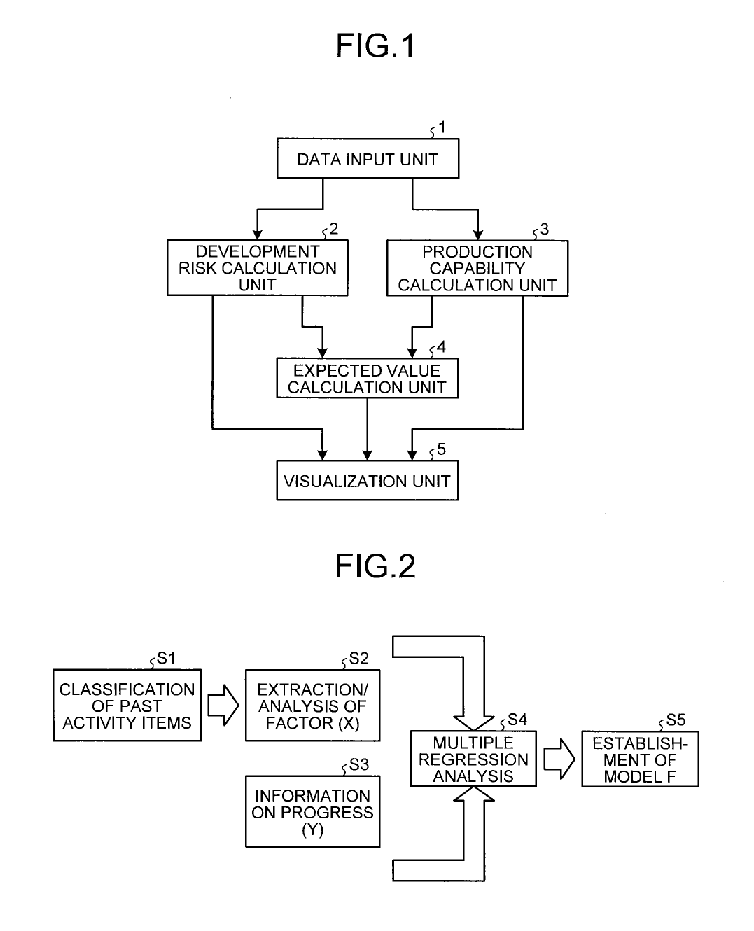

FIG. 1 is a block diagram of a schematic configuration of a production management device according to the embodiment.

Referring to FIG. 1, the production management device is provided with a data input unit 1, a development risk calculation unit 2, a production capability calculation unit 3, an expected value calculation unit 4, and a visualization unit 5. The data input unit 1 inputs data affecting the progress of production. The development risk calculation unit 2 calculates development risks related to development time of the production based on results of classification of the input data. The production capability calculation unit 3 calculates production capabilities by process based on results of analysis of the input data. The expected value calculation unit 4 calculates expected values of production volume by process based on the development risks and the production capabilities. The visualization unit 5 visualizes the development risks, the production capabilities, and the expected values by process.

The development risk calculation unit 2 can calculate development risks based on multiple regression analysis in which a factor affecting the progress of production is an explanatory variable and development time is a dependent variable. The factor affecting the progress of production is qualitative data called nominal scale which is incapable of four arithmetic operations. Thus, the explanatory variable can be defined by a dummy variable called quantification class I that is set to 1 when an option for the factor is selected, and is set to 0 when no option for the factor is selected.

The production capabilities can be represented by lot. When it is assumed that a time taken for production of one lot is a pitch time, the production capability (number of lots/month) can be given by the equation (operation time per production device)÷(pitch time)×(number of production devices).

The development risks can be represented as ranks, and development probabilities can be given to the ranks. The development risks, the production capabilities, and the expected values can be visualized by process in the form of bar graph. The development probabilities can be displayed on the bar graph. The development risks can represent development probabilities with the expected values given.

FIG. 2 is a block diagram illustrating a method for establishing a model in a method for production management according to the embodiment.

Referring to FIG. 2, past activity items for improving production capabilities are classified by process (S1). Then, from the classified activity items, a factor X affecting the progress of production is extracted and analyzed (S2), and information on progress Y is obtained (S3). The factor in relation to approaches may include, process, operation rate, introduction of new devices, and the like, for example. In addition, the factor in relation to degree of dependence on a device manufacturer may include necessity of modification of device hardware, necessity of modification of device software, and the like. The factor in relation to degree of similarity to conventional methods may include development by the same product type or the same machine model, development by a different product type or a different machine model, and the like.

Next, multiple regression analysis is performed with the factor X as an explanatory variable and the progress Y as a dependent variable (S4), and a model F for determining the progress Y from the factor X is established (S5).

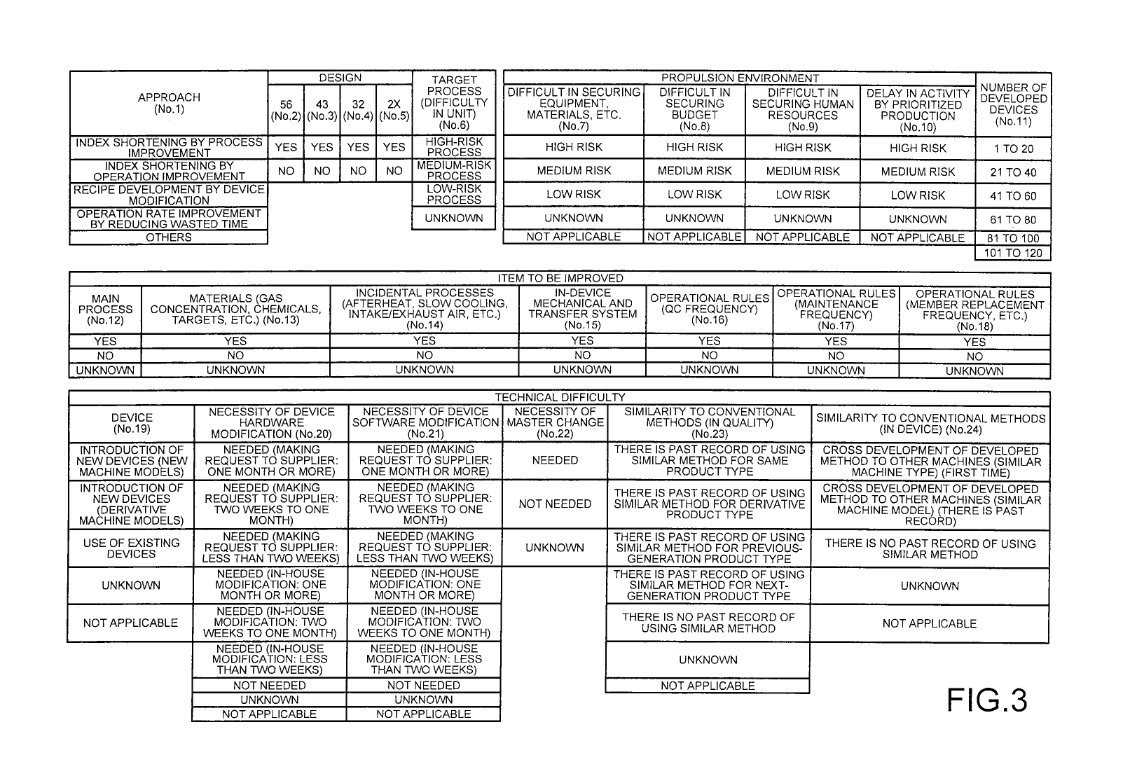

FIG. 3 is a diagram illustrating a list of extraction examples of factors in past activity items.

Referring to FIG. 3, 24 items as factors affecting the progress of production are extracted from the past activity items. These factors can be provided with factor options. For example, the factor approach can be provided with index shortening by process improvement, index shortening by operation improvement, recipe development by device modification, operation rate improvement by reducing wasted time, and others.

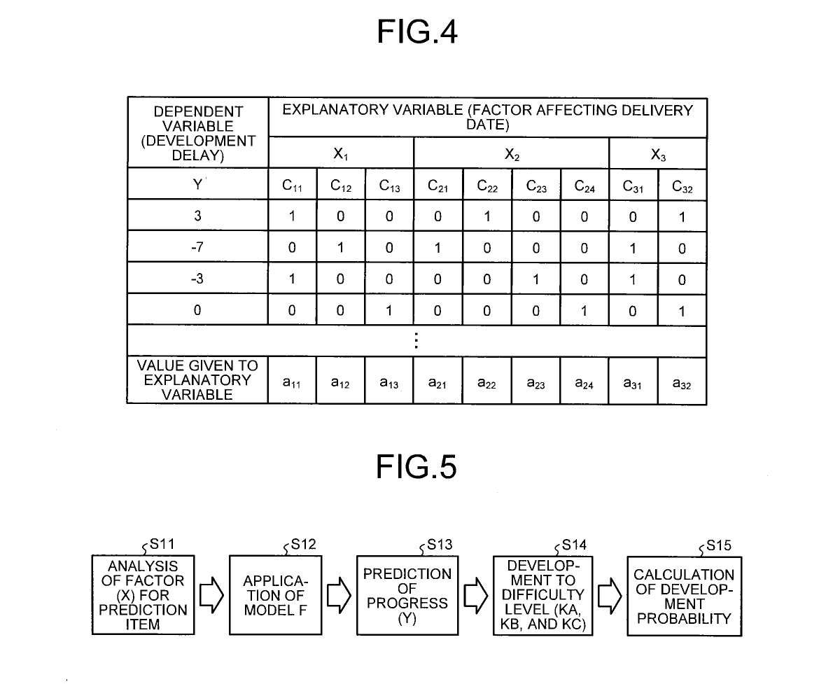

FIG. 4 is a diagram illustrating one example of variables for use in multiple regression analysis illustrated in FIG. 2. In the example of FIG. 4, for simplification of description, explanatory variables (here, factors affecting delivery date) are designated as X₁ to X₃, and a dependent variable (here, development delay) is designated as Y. In addition, a dummy variable that is set to 1 if an option for factor is selected or is set to 0 if no option is selected, is designated as Cᵢⱼ (i=1, 2, . . . , j=1, 2, . . . ), and a value given to the explanatory variable is designated as aᵢⱼ (i=1, 2, . . . , j=1, 2, . . . ). The value given to the explanatory variable refers to a coefficient for predicting a development delay from the factor affecting the delivery date.

Referring to FIG. 4, if the predicted value of the development delay is designated as ̂Y, the solution aᵢⱼ can be obtained by solving the following multiple regression equation:

̂Y=a₁₁·C₁₁+a₁₂·C₁₂+a₁₃·C₁₃

+a₂₁·C₂₁+a₂₂·C₂₂+a₂₃·C₂₃+a₂₄·C₂₄

+a₃₁·C₃₁+a₃₂·C₃₂

In general, if the array representation of ̂Y, Cᵢⱼ, and aᵢⱼ is designated as ̂y, C, and a, the value a to be given to the explanatory variable can be determined by the following equations:

̂y=C·a

a=C⁻¹·̂y

FIG. 5 is a block diagram illustrating a method for calculating a development probability in a prediction item.

Referring to FIG. 5, the factor X affecting the progress of production in relation to a prediction item is analyzed (S11). Next, a model F for determining the progress Y from the factor X is applied (S12) to predict the progress Y (S13). At that time, the progress Y can be obtained by the equation Y=F·X. The model F can use the foregoing multiple regression equation. The progress Y can be expressed by an advance or a delay with respect to a scheduled development date. The prediction item is developed to difficulty level in relation to progress of production (S14). The difficulty level can be defined by difficulty level ranks KA, KB, and KC, for example. Although, in a simple relationship between a predicted value and an actual value, there are large variations in success rate determined from the model F, it is possible to decrease variations in success rate determined from the model F by defining the progress of production by difficulty level ranks. At that time, when a value of difficulty level rank predicted using the model matches an actual value of the difficulty level rank determined by development results, the matched value can be set as a correct difficulty level rank. Next, the development probability with respect to the difficulty level is calculated (S15).

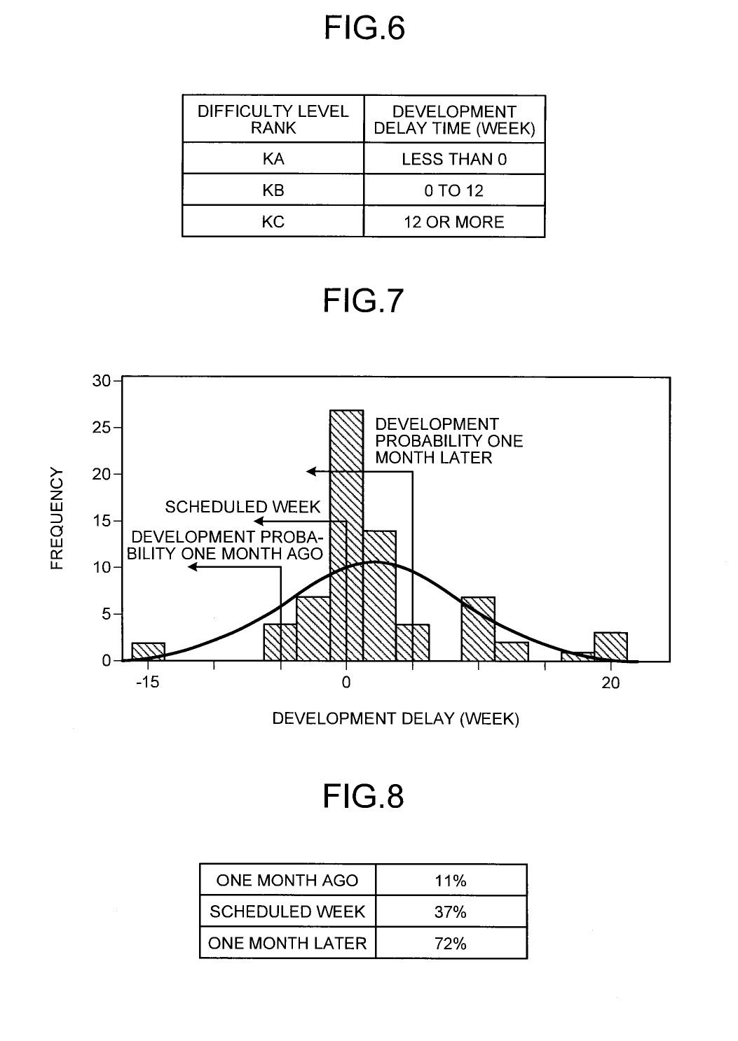

FIG. 6 is a diagram illustrating one example of difficulty level ranks in a prediction item.

Referring to FIG. 6, the longer the development delay time becomes, the more the difficulty level ranks KA, KB, and KC can be increased. For example, the difficulty level rank KA is set with a development delay time of less than 0 week, the difficulty level rank KB is set with a development delay time of 0 to 12 weeks, and the difficulty level rank KC is set with a development delay time of more than 12 weeks.

FIG. 7 is a diagram illustrating distribution of development delays in a prediction item. In the example of FIG. 7, development delays are represented by frequency (number of cases) for past 71 activity items.

Referring to FIG. 7, the development delays in relation to the activity items can be regarded as normal distribution. The average of the development delays is 2.2 weeks, and variation in the development delays is 6.6 weeks. Thus, development probabilities in development delay time can be determined from the area of the normal distribution divided by development delay time.

FIG. 8 is a diagram illustrating one example of development probabilities in a prediction item.

Referring to FIG. 8, if the development delays are regarded as normal distribution, the development probability one month ago is 11%, the development probability in the scheduled week is 37%, and the development probability one month later is 72%, for example. In addition, a positive value of the development delay indicates that the production is delayed, and a negative value of the development delay indicates that the production advances.

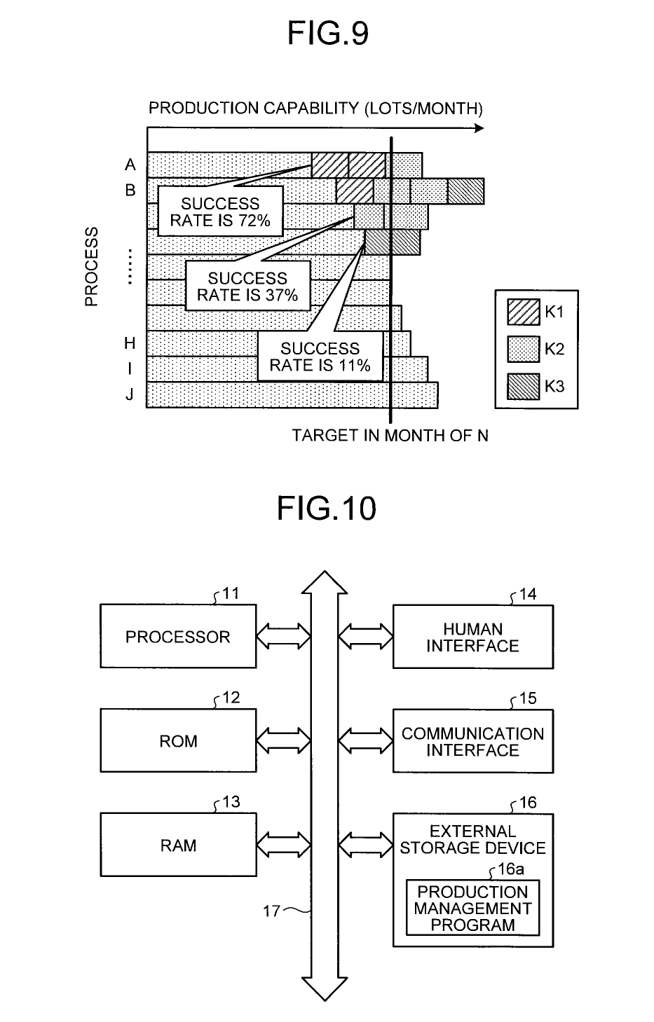

FIG. 9 is a diagram illustrating a display example of success rates according to production capabilities by process.

Referring to FIG. 9, production capabilities are represented in bar graph for respective processes A, B, . . . , H, I, and J. If the production capability is the number of lots per month for respective processes A, B, . . . , H, I, and J, the production capability can be obtained by the equation (pitch time)×(operation time per production device)×(number of production devices). In addition, for one and the same machine model, if the pitch time and the operation time are different among machines, averages can be taken in the same machine model. The processes A, B, . . . , H, I, and J may include lithography process, CVD process, ion implantation process, etching process, and CMP process, for example. If one and the same process is performed more than one time on one and the same wafer, the process can be set as a plurality of processes. For example, if the lithography process is performed five times on one and the same wafer, the lithography process can be set as separate processes.

After the development probabilities are determined with respect to development delays for the respective processes A, B, . . . , H, I, and J, the arithmetic operation (development probability)×(production capability) can be performed to determine expected values for target values in the month of N and display the same on the bar graph. The expected values can be provided with ranges according to the difficulty level ranks illustrated in FIG. 6, for example. In addition, the development probabilities (development risks) with respect to the expected values can be numerically displayed as success rates with respect to the target values in the month of N. In the process B, for example, the expected value K1 refers to the number of produced lots with a success rate of 72%, the expected value K2 refers to the number of produced lots with a success rate of 37%, and the expected value K3 refers to the number of produced lots with a success rate of 11%.

Accordingly, it is possible to quantitatively determine the success rates in the respective processes with respect to the target values in the month of N. Thus, it is possible to determine the necessity for stock building and equipment increase in the respective processes without depending on workers' qualitative instincts and experiences and improve productivity while suppressing occurrence of wasteful spending.

FIG. 10 is a block diagram illustrating a hardware configuration example of a production management device according to the embodiment.

Referring to FIG. 10, the production management device can be provided with a processor 11 including a CPU and the like, a ROM 12 that stores fixed data, a RAM 13 that provides a work area or the like to the processor 11, a human interface 14 that intermediates between a person and a computer, a communication interface 15 that provides a means for communication with the outside, and an external storage device 16 that stores programs for operating the processor 11 and various kinds of data. The processor 11, the ROM 12, the RAM 13, the human interface 14, the communication interface 15, and the external storage device 16 are connected together via a bus 17.

The external storage device 16 may be a magnetic disc such as a hard disc, an optical disc such as a DVD, a portable semiconductor storage device such as a USB memory or a memory card, or the like, for example. The human interface 14 may be a keyboard, a mouse, or a touch panel as input interface, and may be a display or a printer as output interface, and the like, for example. The communication interface 15 may be a LAN card, a modem, or a router for connection with the Internet, a LAN, or the like, for example. The external storage device 16 has installed therein a production management program 16a for causing a computer to execute production management.

The production management program 16a can realize the functions of the data input unit 1, the development risk calculation unit 2, the production capability calculation unit 3, the expected value calculation unit 4, and the visualization unit 5 illustrated in FIG. 1. When the production management program 16a is executed, data affecting the progress of production is input via the human interface 14. Then, at the processor 11, development risks in relation to production development time are calculated based on results of classification of the data, and then production capabilities by process are calculated based on results of analysis of the data. Then, expected values of production volume by process are calculated based on the development risks and the production capabilities. The development risks, the production capabilities, and the expected values are visualized by process on the human interface 14.

The production management program 16a to be executed by the processor 11 may be stored in the external storage device 16 and read into the RAM 13 at execution of the program, or may be stored in advance in the ROM 12, or may be acquired via the communication interface 15. In addition, the production management program 16a may be executed by a stand-alone computer or a cloud computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A production management device, comprising:
a data input unit that inputs data affecting progress of production;
a development risk calculation unit that calculates development risks related to development time of the production based on results of classification of the data;
a production capability calculation unit that calculates production capabilities by process based on results of analysis of the data; and
an expected value calculation unit that calculates expected values of production volume by process based on the development risks and the production capabilities.

2. The production management device according to claim 1, wherein
the development risk calculation unit calculate the development risks based on multiple regression analysis in which a factor affecting the progress of the production is an explanatory variable and the development time is a dependent variable, and
the explanatory variable is defined by a dummy variable that is set to 1 when an option for the factor is selected, and is set to 0 when no option for the factor is selected.

3. The production management device according to claim 1, wherein
the production capabilities are represented by lot, and
when it is assumed that a time taken for production of one lot is a pitch time, the production capabilities are obtained by equation (pitch time)×(operation time per production device)×(number of production devices).

4. The production management device according to claim 1, comprising a visualization unit that visualizes the development risks, the production capabilities, and the expected values by process.

5. The production management device according to claim 4, wherein
the development risks are represented as difficulty level ranks, and
development probabilities are given to the difficulty level ranks.

6. The production management device according to claim 5, wherein
the visualization unit visualizes the development risks, the production capabilities, and the expected values by process in the form of bar graph, and displays the development probabilities on the bar graph.

7. The production management device according to claim 5, wherein, based on multiple regression analysis in which the factor affecting the progress of the production is an explanatory variable and the progress is a dependent variable, a model for determining the progress from the factor is established.

8. The production management device according to claim 7, wherein the progress is expressed by an advance or a delay with respect to a scheduled development date.

9. The production management device according to claim 8, wherein
development delays in relation to activity items are regarded as normal distribution, and
development probabilities in development delay time are determined from the area of the normal distribution divided by the development delay time.

10. The production management device according to claim 7, wherein, when a value of the difficulty level rank predicted using the model matches an actual value of the difficulty level rank determined by development results, the matched value is set as a correct difficulty level rank.

11. A production management program for causing a computer to execute the steps of:
inputting data affecting progress of production;
calculating development risks related to development time of the production based on results of classification of the data;
calculating production capabilities by process based on results of analysis of the data; and
calculating expected values of production volume by process based on the development risks and the production capabilities.

12. The production management program according to claim 11, wherein
the development risks are calculated based on multiple regression analysis in which a factor affecting the progress of the production is an explanatory variable and the development time is a dependent variable, and
the explanatory variable is defined by a dummy variable that is set to 1 when an option for the factor is selected, and is set to 0 when no option for the factor is selected.

13. The production management program according to claim 11, wherein
the production capabilities are represented by lot, and
when it is assumed that a time taken for production of one lot is a pitch time, the production capabilities are obtained by equation (pitch time)×(operation time per production device)×(number of production devices).

14. The production management program according to claim 11, wherein the development risks, the production capabilities, and the expected values are visualized by process.

15. The production management program according to claim 14, wherein
the development risks are represented as difficulty level ranks, and
development probabilities are given to the difficulty level ranks.

16. The production management program according to claim 15, wherein
the development risks, the production capabilities, and the expected values are visualized by process in the form of bar graph, and
the development probabilities are displayed on the bar graph.

17. The production management program according to claim 15, wherein, based on multiple regression analysis in which the factor affecting the progress of the production is an explanatory variable and the progress is a dependent variable, a model for determining the progress from the factor is established.

18. The production management program according to claim 17, wherein the progress is expressed by an advance or a delay with respect to a scheduled development date.

19. The production management program according to claim 18, wherein
development delays in relation to activity items are regarded as normal distribution, and
development probabilities in development delay time are determined from the area of the normal distribution divided by the development delay time.

20. The production management program according to claim 17, wherein, when a value of the difficulty level rank predicted using the model matches an actual value of the difficulty level rank determined by development results, the matched value is set as a correct difficulty level rank.
